(19) United States
(12) Patent Application Publication
(10) Pub. No.: US 2022/0147841 A1
(43) Pub. Date: May 12, 2022

(54) SYSTEMS AND METHODS FOR ENHANCED MACHINE LEARNING USING HIERARCHICAL PREDICTION AND COMPOUND THRESHOLDS

(71) Applicant: GlobalWafers Co., Ltd., Hsinchu (TW)

(72) Inventors: Guang-Shin Chen, Hsinchu (TW); Chun-Hsien Tu, Hsinchu (TW); Tsz-En Hung, Hsinchu (TW)

(21) Appl. No.: 17/454,086

(22) Filed: Nov. 9, 2021

Related U.S. Application Data
(60) Provisional application No. 63/112,028, filed on Nov. 10, 2020.

(51) Int. Cl. G06N 5/02; G06N 5/04

(52) U.S. Cl. CPC G06N 5/022; G06N 5/04

(57) ABSTRACT

A computer device is programmed to receive a plurality of real-time datasets from one or more sensors associated with a tool to be analyzed, calibrate the plurality of real-time datasets, generate a time slide window for each real-time dataset of the plurality of real-time datasets, generate a random probability distribution curve, compare the random probability distribution curve to each time slide window to determine if the time slide window includes anomaly data, and generate prediction results based on the comparison.

### CROSS-REFERENCE TO RELATED APPLICATIONS

This application claims priority to U.S. Provisional Patent Application Ser. No. 63/112,028, filed Nov. 10, 2020, the entire contents and disclosure of which are incorporated herein by reference.

### FIELD

The field relates generally to enhanced machine learning and, more specifically, to enhance machine learning for anomaly detection using hierarchical prediction and compound thresholds.

### BACKGROUND

Semiconductor wafers are commonly used as substrates in the production of integrated circuit (IC) chips. Chip manufacturers require wafers that have extremely flat and parallel surfaces to ensure that a maximum number of chips can be fabricated from each wafer. After being sliced from an ingot, wafers typically undergo grinding and polishing processes designed to improve certain surface features, such as flatness and parallelism.

Simultaneous double side grinding operates on both sides of a wafer at the same time and produces wafers with highly planarized surfaces. Grinders that perform double side grinding include. These grinders use a wafer-clamping device to hold the semiconductor wafer during grinding. The clamping device typically comprises a pair of hydrostatic pads and a pair of grinding wheels. The pads and wheels are oriented in opposed relation to hold the wafer therebetween in a vertical orientation. The hydrostatic pads beneficially produce a fluid barrier between the respective pad and wafer surface for holding the wafer without the rigid pads physically contacting the wafer during grinding. This reduces damage to the wafer that may be caused by physical clamping and allows the wafer to move (rotate) tangentially relative to the pad surfaces with less friction. While this grinding process can improve flatness and/or parallelism of the ground wafer surfaces, it can cause degradation of the topology of the wafer surfaces. Specifically, misalignment of the hydrostatic pad and grinding wheel clamping planes are known to cause such degradation. Furthermore, any degradation in any of the tools used in the process can allow potentially hundreds of wafers to be processed before problems may be detected. Furthermore, each individual production line and device may have particular characteristics, which may vary from device to device. Accordingly, there is a need for a system for detecting and determining when tools are about to degrade, require re-alignment, or otherwise cause issues on the productions line. However, many systems for training systems to recognize when a tool may be about to fail are trained just using historical data and may suffer from overfitting. Accordingly, a training system for training a system to recognize when a tool is about to fail is needed.

This Background section is intended to introduce the reader to various aspects of art that may be related to various aspects of the present disclosure, which are described and/or claimed below. This discussion is believed to be helpful in providing the reader with background information to facilitate a better understanding of the various aspects of the present disclosure. Accordingly, it should be understood that these statements are to be read in this light, and not as admissions of prior art.

### BRIEF SUMMARY

In one aspect, a computer device includes at least one processor in communication with at least one memory device. The at least one processor is programmed to receive a plurality of real-time datasets from one or more sensors associated with a tool to be analyzed. The at least one processor is also programmed to calibrate the plurality of real-time datasets. The at least one processor is further programmed to generate a time slide window for each real-time dataset of the plurality of real-time datasets. In addition, the at least one processor is programmed to generate a random probability distribution curve. Moreover, the at least one processor is programmed to compare the random probability distribution curve to each time slide window to determine if the time slide window includes anomaly data. Furthermore, the at least one processor is programmed to generate prediction results based on the comparison.

In another aspect, a method for analyzing a tool is implemented on a computer device including at least one processor in communication with at least one memory device. The method includes receiving a plurality of real-time datasets from one or more sensors associated with a tool to be analyzed. The method also includes calibrating the plurality of real-time datasets. The method further includes generating a time slide window for each real-time dataset of the plurality of real-time datasets. In addition, the method includes generating a random probability distribution curve. Moreover, the method includes comparing the random probability distribution curve to each time slide window to determine if the time slide window includes anomaly data. Furthermore, the method includes generating prediction results based on the comparison.

Various refinements exist of the features noted in relation to the above-mentioned aspects. Further features may also be incorporated in the above-mentioned aspects as well. These refinements and additional features may exist individually or in any combination. For instance, various features discussed below in relation to any of the illustrated embodiments may be incorporated into any of the above-described aspects, alone or in any combination.

### BRIEF DESCRIPTION OF THE DRAWINGS

FIG. 1 illustrates a block diagram of a system for training and using machine learning including hierarchical prediction and compound thresholds in accordance with an embodiment of the disclosure.

FIG. 2 is a flowchart illustrating an example process of generating training datasets for use training system shown in FIG. 1.

FIG. 3 is a flowchart illustrating an example process of using the system shown in FIG. 1.

FIG. 4 is a flowchart illustrating an example process of using prediction data from the system shown in FIG. 1.

FIG. 5 illustrates a block diagram for a system for training and using machine learning including hierarchical prediction and compound thresholds.

FIG. 6 illustrates an example configuration of a user computer device used in the system shown in FIG. 1 and the system shown in FIG. 5, in accordance with one example of the present disclosure

FIG. 7 illustrates an example configuration of a server computer device used in the system shown in FIG. 1 and the system shown in FIG. 5, in accordance with one example of the present disclosure

FIG. 8 is an example graph for illustrating the results of analysis performed by the processes shown in FIGS. 2-4 using the system shown in FIG. 1.

Corresponding reference characters indicate corresponding parts throughout the several views of the drawings.

### DETAILED DESCRIPTION

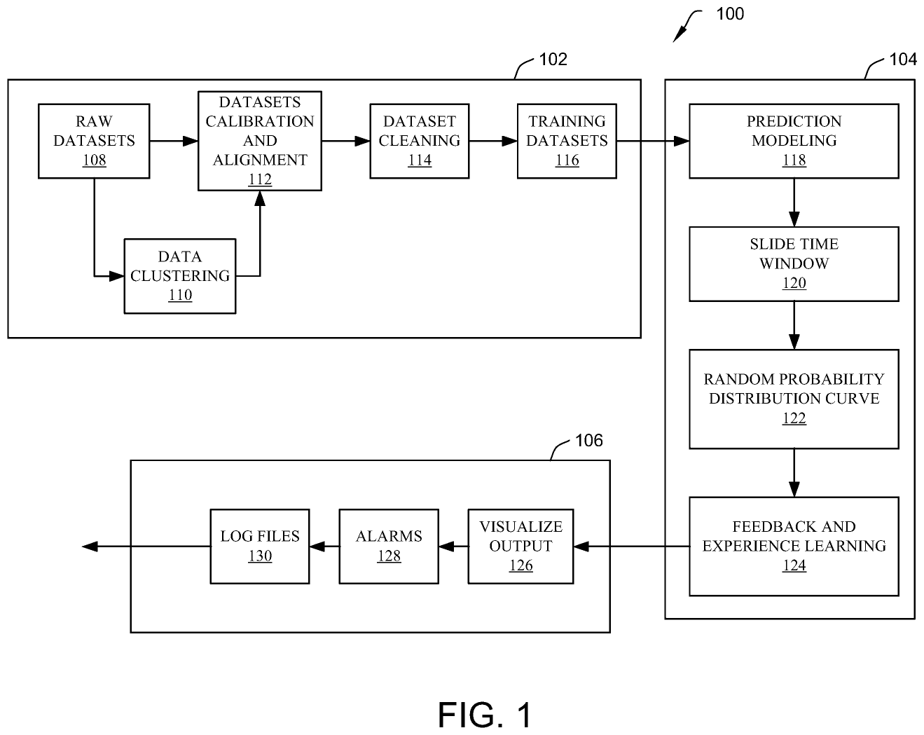

FIG. 1 illustrates a block diagram of a system 100 for training and using machine learning including hierarchical prediction and compound thresholds in accordance with at least one embodiment of the disclosure. In the example embodiment, the system 100 is related to one or more production lines for producing a product, where the product is processed by one or more tools. For example, the production line could be for producing and polishing silicon wafers and the tool is a grinder or polisher for the wafers. While, the systems and methods described herein are described using tools and production lines, ones having skill in the art would understand that the systems and methods described herein could be used with other assembly lines, other tools, and other modeling situations where overfitting can occur and are not limited to production environments.

The system 100 includes an intake portion 102, a processing portion 104, and an output portion 106. The intake portion 102 includes receiving, cleaning, and preprocessing the data. The processing portion 104 includes applying the data to the model and further processing the data to receive one or more predictions. The output portion 106 includes formatting and displaying the data, including providing alarms as necessary.

The intake portion 102 is capable of receiving raw datasets 108. The raw datasets 108 can include historical data for training purposes. The raw datasets 108 can also include live or real-time sensor data that is received from one or more sensors or measuring devices. The raw datasets 108 can include data that measures a product before and after the product has been processed by a tool in question. The raw datasets 108 can be organized by a data clustering component 110. The data clustering component 110 performs exploratory data analysis on the raw datasets 108 to organize the data in the raw datasets 108 into datasets by clustering or grouping based on similarities. In the example embodiment, the data clustering component 110 is used to cluster raw datasets 108 that have been received from sensors or measuring devices. In the example embodiment, the training datasets have already been organized into data clusters. The data clustering groups similar data in groups. The similarity may be related to time sequences, results, or other relationships.

The data calibration and alignment component 112 can receive either the raw datasets 108, such as training datasets, which may have been already clustered, or those that have been clustered by the data clustering component 110, such as sensor data. The data calibration and alignment component 112 prepares the anomaly data and the safe or clean data according to the history. In some embodiments, the data calibration and alignment component 112 sorts the anomaly data and the safe data into separate datasets. The anomaly data includes data where an actual anomaly occurred. The safe data is data without any anomalies and can include false alarm data. In some embodiments, a dataset does not cleanly fit into either the anomaly dataset or the clean dataset. In these embodiments, the dataset cleaning component 114 discards that dataset. The dataset cleaning component 114 removes noisy data, such as the data which cannot be classified as either clean or anomaly data. After the data is cleaned, the training datasets 116 can be sent to the processing portion 104. In some embodiments, one or more characteristics of noisy data is predefined by subject matter experts. The dataset cleaning component 114 compares the datasets to the one or more characteristics of noisy data to determine if the dataset contains noisy data.

In the processing portion 104, the training datasets 116 are sent to the prediction modeling component 118. The prediction modeling component 118 takes the anomaly and safe data and uses the model to classify the individual datasets as either anomaly or safe data. The prediction modeling component 118 performs time series data prediction.

The slide time window component 120 takes the classified data and generates a window of time leading up to the information to be analyzed. For example, if the data is divided into one minute time segments, the slide time window component 120 may combine a one minute segment to be analyzed with the 29 minutes before the one minute segment. This allows the system 100 to analyze the time that lead up to the one minute segment. When training, this trains the system 100 to analyze the time before an anomaly to learn what leads up to the anomaly. This can allow the system 100 to predict when another anomaly may occur by detecting a similar lead-up to the anomaly. For safe data, this allows the system 100 to learn what safe data looks like. If changes in the data occur, but the lead up is similar to safe data from training, the system 100 may categorize the data being analyzed as safe. While 30 minute time windows are described herein, other size time windows may be analyzed depending on the situation and item being analyzed. For example, in some embodiments, the degradation or change in the operation of a device may be more gradual. In these embodiments, the slide time window component 120 may analyze 30 second segments of data taken over a two week period, or any other combination as necessary to detect the anomalies.

The random probability distribution curve component 122 analyzes the datasets with upper bound limits. The random probability distribution curve component 122 uses random probability to generate upper bound limits for detection purposes. When the data in the datasets exceeds the generated upper bound limits, then the system 100 marks the corresponding data as an anomaly. The random probability distribution curve component 122 determines an upper limit for each point in time analyzed. This line is used as a compound threshold to determine whether the data is safe or contains an anomaly. The random probability distribution curve defines a confidence interval of the random probability distribution as the abnormal warning boundary of the prediction curve generated for each time window. The boundary is a dynamic random probability distribution.

In at least one embodiment, the random probability curve is generated using parameters n and p as the discrete probability distribution of the number of successes in a sequence of n independent experiments, each asking a yes-no question, and each with its own Boolean-valued outcome: success/yes/true/one (with probability p) or failure/no/false/zero (with probability q=1−p). The random probability curve can be generated using A single success/failure experiment called a Bernoulli trial or Bernoulli experiment, where the sequence of outcomes is a Bernoulli process.

During training, the feedback and experience learning component 124 compares the results of the prediction of the system 100 to the actual data. For example, did the dataset contain an anomaly and did the system 100 detect that anomaly. Or did the system 100 predict an anomaly on safe data. The feedback and experience learning component 124 traces back to the actual physical environment factors predicted in the past. This includes the correlation of the operating settings of the organic parameters, the prediction accuracy, the correct prediction rate, and the false alarm rate.

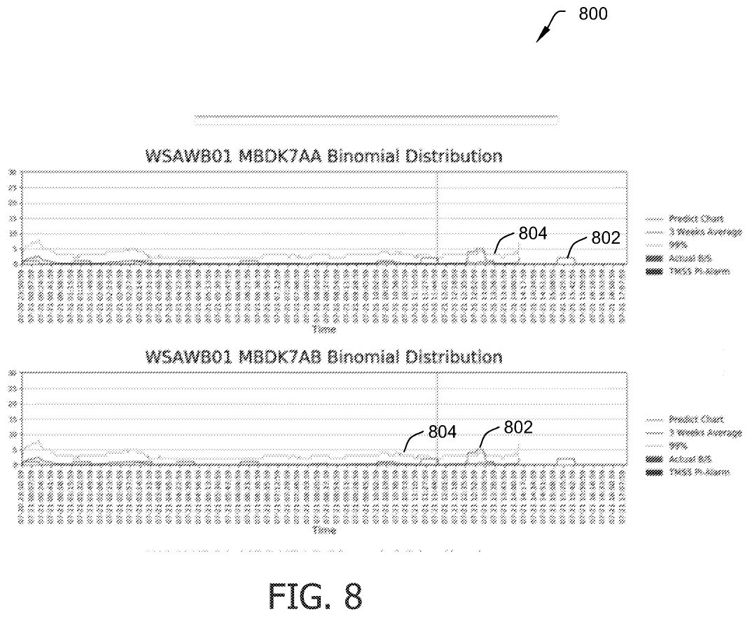

The output portion 106 orders the data and predictions so that a user may view it, such as via a webpage. The output portion 106 can includes a visualize output component 126, an alarms component 128, and/or a log files component 130. The visualize output component 126 can organize the data into viewable data, such as by creating a dashboard or graph to display the data. An example of one graph generated by the visualize output component 126 can be seen in FIG. 8. The alarms component 128 can trigger one or more alarms to inform the user of a potential event. The log files component 130 can store the data and the prediction results of the analysis of the data for future review.

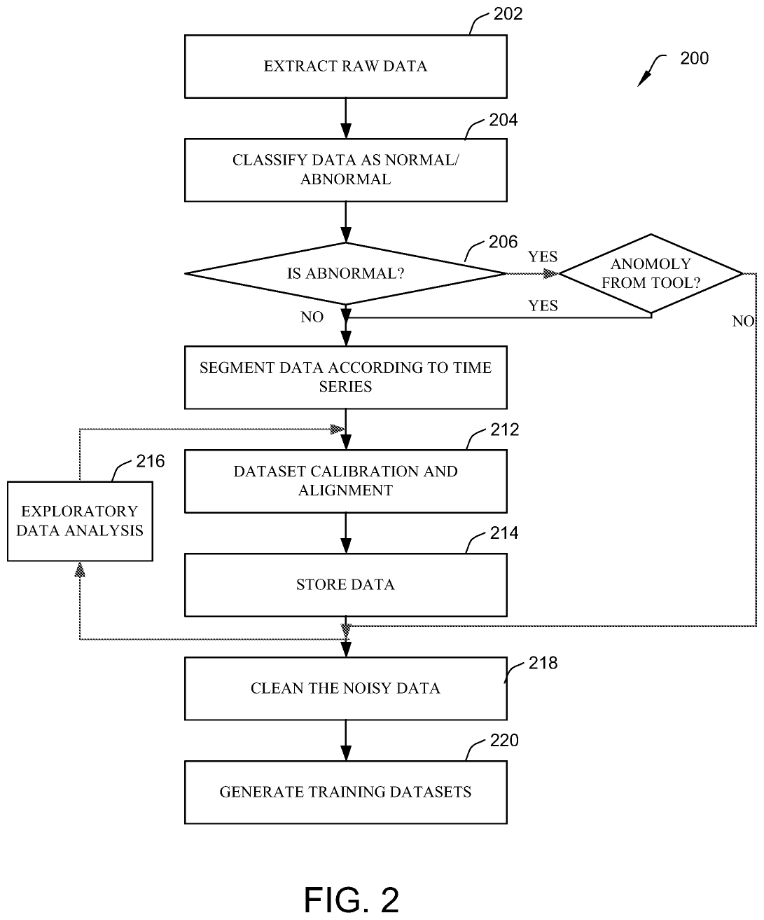

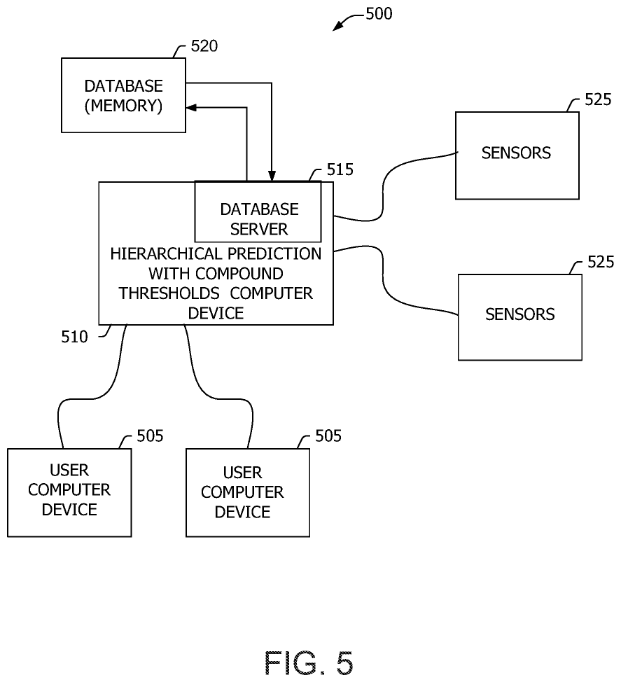

FIG. 2 is a flowchart illustrating an example process 200 of generating training datasets for use training system 100 (shown in FIG. 1). In the example embodiment, the steps of process 200 are performed by the Hierarchical Prediction with Compound Thresholds (HPCT) computer device 510 (shown in FIG. 5). Process 200 includes steps for generating training datasets for a model or the system 100 to be able to classify data as whether or not the data contains an anomaly.

The HPCT computer device 510 extracts 202 raw data. In the example embodiment, the raw data is historical datasets, where the historical datasets includes a mixture of normal datasets and abnormal datasets. For the purposes of this discussion, an abnormal dataset includes one or more anomalies and a normal dataset does not include any anomalies.

For each dataset, the HPCT computer device 510 classifies 204 the corresponding datasets as either abnormal (containing an anomaly) or normal (not containing an anomaly). Then the HPCT computer device 510 sorts 206 the datasets based on whether or not the data is abnormal. If the dataset is not abnormal, then the dataset is sent to Step 210. If the data is abnormal, the HPCT computer device 510 determines 208 if the anomaly is from the tool being analyzed. If not, then the dataset is discarded. The anomaly might be from a user error or other non-tool issue shown in the dataset. Otherwise, if it is confirmed that the anomaly is from the tool being analyzed, the HPCT computer device 510 proceeds to Step 210.

The HPCT computer device 510 segments 210 the data according to the time series. In some embodiments, the HPCT computer device 510 segments 210 the datasets into time slices of a predetermined amount of time, such as 10 seconds or one minute depending on the situation. In some embodiments, the HPCT computer device 510 also attaches an amount of preceding data from prior to the time of the dataset.

The HPCT computer device 510 performs 212 dataset calibration and alignment to ensure that the dataset size and format matches the size and format of other datasets. For example, the HPCT computer device 510 may remove a portion of the dataset so that the dataset is the same size as other datasets. Or the HPCT computer device 510 may trim all of the datasets to match the shortest dataset with an anomaly.

The HPCT computer device 510 stores 214 the datasets, such as in the database 520 (shown in FIG. 5). The HPCT computer device 510 performs 216 exploratory data analysis, such as clustering on the datasets. Once the clustering is complete, the HPCT computer device 510 returns to Step 212 and continues the process 200. In the exploratory data analysis 216 step, the HPCT computer device 510 determines the type and structure of the data provided. The HPCT computer device 510 checks the datasets to determine if there are any outliers or unusual values in the data. The HPCT computer device 510 also determines any correlation or relationships between the data. In addition, while the complete training data (220) may be fixed in some embodiments, different tools being analyzed might have their own timing or indicators. Accordingly, the prediction model may have to be retrained for different tools or devices to be analyzed.

The HPCT computer device 510 cleans 218 the noisy data. Then the HPCT computer device 510 uses the cleaned datasets to generate the training datasets. In some embodiments, one or more characteristics of noisy data is predefined by subject matter experts. The HPCT computer device 510 compares the datasets to the one or more characteristics of noisy data to determine if the dataset contains noisy data. The HPCT computer device 510 is programmed to look for potential noisy data based on the performance and prior anomalies of the tools or equipment's historical behavior.

The training datasets are used to train the model and/or system 100 to recognize when live data has anomalies. In some embodiments, the training datasets are used by the HPCT computer device 510 and/or the processing portion 104 (shown in FIG. 1) for training purposes.

For example, the HPCT computer device 510 receives a plurality of data for training the model. The HPCT computer device 510 extracts 202 the raw data into datasets. For each dataset, the HPCT computer device 510 attempts to classify 204 the data as either normal or abnormal. If the dataset is abnormal, the HPCT computer device 510 determines 208 if the anomaly in the dataset is from the tool to be analyzed or from another source, such as, but not limited to, human error or noise. The dataset is not further analyzed if the source is not the tool. If the dataset is considered normal or the anomaly is due to the tool, the HPCT computer device 510 segments 210 the data according to the time series, so that the dataset is of a specific time size or has a specific number of data points. The HPCT computer device 510 calibrates 212 the dataset to ensure that the dataset size and format matches the size and format of other datasets. The HPCT computer device 510 stores 214 the data. In some embodiments, the HPCT computer device 510 performs clustering analysis on the datasets. For example, after a plurality of datasets are calibrated 212 and aligned, the HPCT computer device 510 performs 216 exploratory data analysis on the plurality of datasets, which includes data clustering. The HPCT computer device 510 cleans 218 the noisy data and then generates 220 a plurality of training datasets based on the stored datasets.

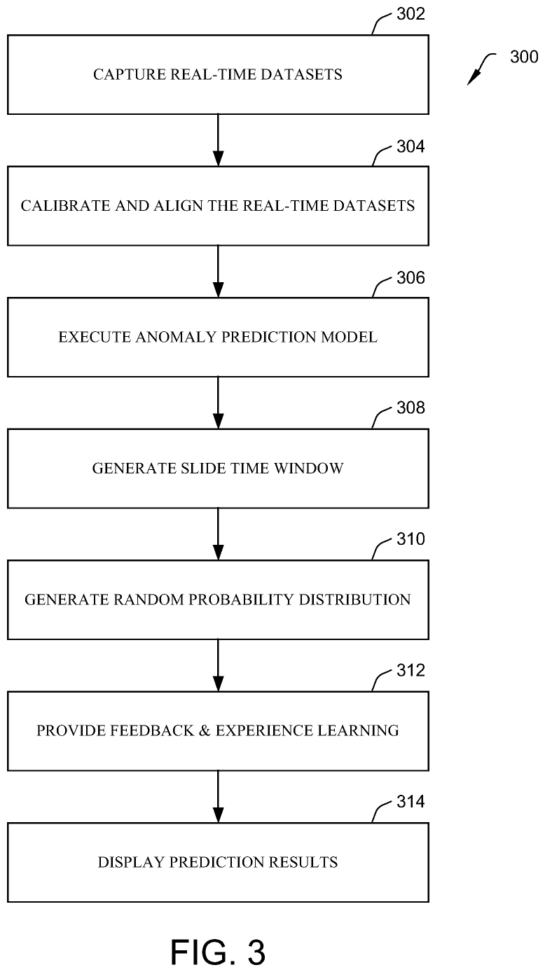

FIG. 3 is a flowchart illustrating an example process 300 of using the system 100 (shown in FIG. 1). In the example embodiment, the steps of process 300 are performed by the Hierarchical Prediction with Compound Thresholds (HPCT) computer device 510 (shown in FIG. 5). Process 300 includes steps for using datasets to be able to classify data as whether or not the data contains an anomaly. In the example embodiments, system 100 is trained and process 300 is used for analyzing live or real-time data from one or more sensors or measuring devices associated with the tool to be analyzed. In some embodiments, Steps 304-314 of process 300 are used for training system 100 using the training datasets generated by process 200 (shown in FIG. 2).

The HPCT computer device 510 captures 302 the real-time datasets from at least one of the sensors and or measurement devices monitoring the tool. In some embodiments, the real-time datasets include data subsequent to the tool. In other embodiments, the real-time datasets include data prior to and subsequent to the tool.

The HPCT computer device 510 calibrates 304 and aligns the real-time datasets. This ensures that the time blocks for each dataset include the same amount of time and information from the same sensors. In some embodiments, the HPCT computer device 510 divides the time in the datasets to align with the time blocks that were used in the training datasets. For example, if the training datasets included one minute time blocks, the HPCT computer device 510 adjusts the real-time datasets into one minute time blocks as well. In different embodiments, different data collection sets may collect data along different timelines. The HPCT computer device 510 aligns the datasets with the desired time sequence.

The HPCT computer device 510 executes 306 the anomaly prediction model on the real-time datasets to determine if the datasets include safe data or anomaly data based on the trained model. Then the HPCT computer device 510 generates 308 slide time windows for each of the real-time datasets. The HPCT computer device 510 attaches the information that occurs prior to the dataset for a pre-determined time period. For example, the HPCT computer device 510 could attach the information that occurs 30 minutes, two hours, or 6 days before the real-time dataset to be analyzed. This turns the discrete data in the dataset into continuous data.

The HPCT computer device 510 generates 310 the random probability distribution curve to analyze the datasets with upper bound limits. The random probability distribution curve uses random probability to generate upper bound limits for detection purposes. When the data in the datasets exceeds the generated upper bound limits, then the HPCT computer device 510 marks the corresponding data as an anomaly. The random probability distribution curve determines an upper limit for each point in time analyzed. This line is used as a compound threshold to determine whether the data is safe or contains an anomaly.

During training, the HPCT computer device 510 provides 312 feedback and experience learning to compares the results of the prediction to the actual data. For example, did the dataset contain an anomaly and did the HPCT computer device 510 detect that anomaly. Or did the HPCT computer device 510 predict an anomaly on safe data. During live data, the HPCT computer device 510 uses past data to determine if an alarm should be raised. In at least one embodiment, the HPCT computer device 510 compares the number of pre-alarm alerts that have been raised during a current time period to the number of pre-alarm alerts that were raised in a previous time period. If the current number of pre-alarms is greater than or equal to the previous number of pre-alarms, the HPCT computer device 510 raises an actual alarm. Otherwise, the HPCT computer device 510 stores the results of the analysis of the dataset and continues to the next real-time dataset.

The HPCT computer device 510 then displays 314 the prediction results. For example, the HPCT computer device 510 captures 302 a real-time dataset that contains an anomaly. The HPCT computer device 510 calibrates 304 the real-time dataset to include a 30 second slice of time to match the other slices of times that the system 100 was trained on. This may include waiting to capture 302 more data, using previously captured data, and/or trimming some data from the real-time dataset to calibrate 304 the real-time dataset for the model. Then the HPCT computer device 510 executes 306 the anomaly prediction model. The model was trained using the training datasets from process 200.

The HPCT computer device 510 generates 308 the time slide window for the real-time dataset. For example, the time slide window may include the thirty minutes of data prior to the real-time dataset. The HPCT computer device 510 calculates the random probability distribution curve to determine the dynamic threshold for prediction to generate an effective prediction curve. The HPCT computer device 510 compares the real-time dataset to the random probability distribution curve. If the real-time dataset does not exceed the random probability distribution curve at any point, then the data is considered normal. If the real-time dataset exceeds the random probability distribution curve at any point, then the HPCT computer device 510 raises a pre-alarm. The HPCT computer device 510 compares the current number of pre-alarms for a current time period to the number of pre-alarms in a previous time period. If the current number of pre-alarms meets or exceeds the previous number, then a full alarm is raised and displayed 314 to a user.

When the HPCT computer device 510 is training the model, then the HPCT computer device 510 compares the pre-alarm trigger to the actual data to determine if there was an anomaly. If there was, then the HPCT computer device 510 marks that as a success. If there was not, then the HPCT computer device 510 marks the event as a false alarm and uses the feedback and experience learning component 124 to update the model.

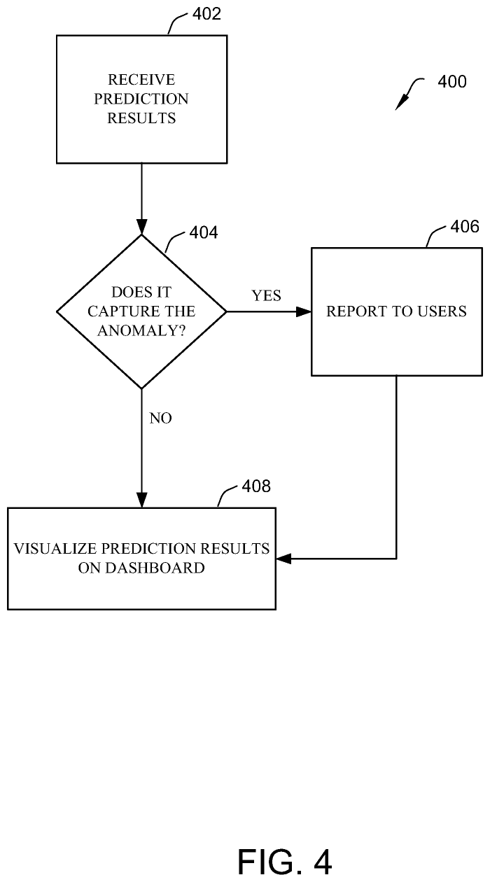

FIG. 4 is a flowchart illustrating an example process 400 of using prediction data from the system 100 (shown in FIG. 1). In the example embodiment, the steps of process 400 are performed by the Hierarchical Prediction with Compound Thresholds (HPCT) computer device 510 (shown in FIG. 5). Process 400 includes steps for displaying the prediction results as described in Step 314 (shown in FIG. 3).

The HPCT computer device 510 receives 402 the prediction results, such as those generated in process 300 (shown in FIG. 3). The HPCT computer device 510 determines 404 if the prediction results capture an anomaly. If yes, then the HPCT computer device 510 reports 406 the anomaly to the users, such as by sending an alarm or notification to one or more users. The HPCT computer device 510 also visualizes 408 the prediction results on a dashboard for the users. In the example embodiment, the prediction results are visualized by displaying them on a graph of a dashboard on a webpage for the user to view, such as illustrated in FIG. 8. In other embodiments, the prediction results can be displayed to users in a plurality of different ways depending on the user's preferences.

FIG. 5 is a simplified block diagram of an example system 500 for training and using machine learning including hierarchical prediction and compound thresholds. In the example embodiment, system 500 is used for analyzing tool wear to determine when maintenance of the tools is required. In addition, system 500 is a real-time data analyzing and classifying computer system that includes a Hierarchical Prediction with Compound Thresholds (HPCT) computer device 510 (also known as a HPCT server) configured to analyze tool performance and predict future states based on the analysis.

In the example embodiment, a sensor 525 is configured to receive inputs about a current status of one or more tools on an assembly line. In some embodiments, the sensor 525 measures one or more attributes or characteristics of a product before and after the tool has been used on the product. In other embodiments, the sensor 525 measures one or more attributes or characteristics of the tool itself. The sensor 525 connects to the HPCT computer device 510 through various wired or wireless interfaces including without limitation a network, such as a local area network (LAN) or a wide area network (WAN), dial-in-connections, cable modems, Internet connection, wireless, and special high-speed Integrated Services Digital Network (ISDN) lines. The sensor 525 receives data about the surface of a wafer and reports that data to the HPCT computer device 510. In other embodiments, the sensor 525 is in communication with one or more user computer devices 505 and the user computer devices 505 route the measurement data to the HPCT computer device 510 in real-time or near real-time. In some embodiments, a first sensor 525 measures an attribute of the product prior to the tool and a second sensor 525 measures the same attribute of the product after the tool.

As described above in more detail, the HPCT computer device 510 is programmed to receive sensor data of tools in real-time to predict when issues may arise with the tools to allow the system 500 to respond to changes that would cause issues with the final product. The HPCT computer device 510 is programmed to 1) receive current data; 2) detect at least one anomaly based on the current data; 3) generate a time window for the anomaly; 4) generate a random probability distribution curve for the time window; 5) compare the time window to the random probability distribution curve; and 6) notify a user if the at least one anomaly exceeds the random probability distribution curve.

In the example embodiment, user computer devices 505 are computers that include a web browser or a software application, which enables user computer devices 505 to communicate with the HPCT computer device 510 using the Internet, a local area network (LAN), or a wide area network (WAN). In some embodiments, user computer devices 505 are communicatively coupled to the Internet through many interfaces including, but not limited to, at least one of a network, such as the Internet, a LAN, a WAN, or an integrated services digital network (ISDN), a dial-up-connection, a digital subscriber line (DSL), a cellular phone connection, a satellite connection, and a cable modem. User computer devices 505 can be any device capable of accessing a network, such as the Internet, including, but not limited to, a desktop computer, a laptop computer, a personal digital assistant (PDA), a cellular phone, a smartphone, a tablet, a phablet, or other web-based connectable equipment.

A database server 515 is communicatively coupled to a database 520 that stores data. In one embodiment, database 520 is a database that includes historical data, the model, and sensor data. In some embodiments, database 520 is stored remotely from HPCT computer device 510. In some embodiments, database 520 is decentralized. In the example embodiment, a person can access database 520 via user computer devices 505 by logging onto HPCT computer device 510.

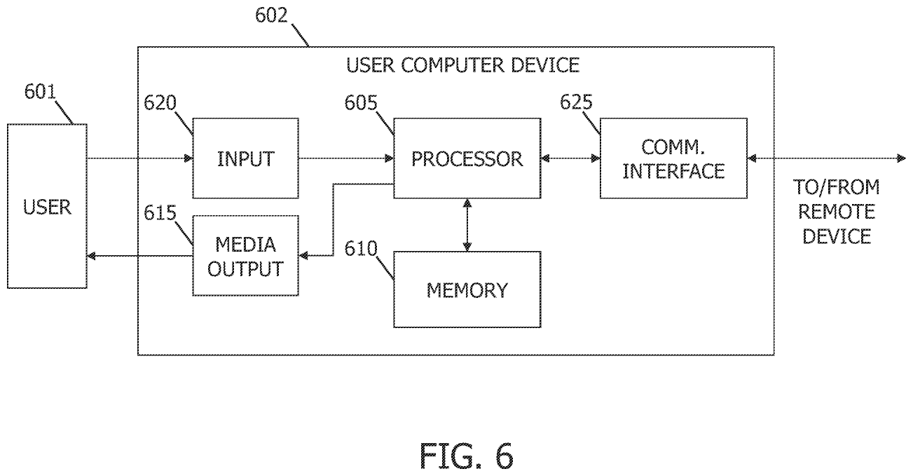

FIG. 6 illustrates an example configuration of client system shown in FIG. 5, in accordance with one embodiment of the present disclosure. User computer device 602 is operated by a user 601. User computer device 602 may include, but is not limited to, sensor 525, HPCT computer device 510, and user computer devices 505 (all shown in FIG. 5). User computer device 602 includes a processor 605 for executing instructions. In some embodiments, executable instructions are stored in a memory area 610. Processor 605 may include one or more processing units (e.g., in a multi-core configuration). Memory area 610 is any device allowing information such as executable instructions and/or transaction data to be stored and retrieved. Memory area 610 may include one or more computer-readable media.

User computer device 602 also includes at least one media output component 615 for presenting information to user 601. Media output component 615 is any component capable of conveying information to user 601. In some embodiments, media output component 615 includes an output adapter (not shown) such as a video adapter and/or an audio adapter. An output adapter is operatively coupled to processor 605 and operatively coupleable to an output device such as a display device (e.g., a cathode ray tube (CRT), liquid crystal display (LCD), light emitting diode (LED) display, or “electronic ink” display) or an audio output device (e.g., a speaker or headphones). In some embodiments, media output component 615 is configured to present a graphical user interface (e.g., a web browser and/or a client application) to user 601. A graphical user interface may include, for example, an interface for viewing the results of the analysis of one or more tools. In some embodiments, user computer device 602 includes an input device 620 for receiving input from user 601. User 601 may use input device 620 to, without limitation, select a tool to view the analysis of. Input device 620 may include, for example, a keyboard, a pointing device, a mouse, a stylus, a touch sensitive panel (e.g., a touch pad or a touch screen), a gyroscope, an accelerometer, a position detector, a biometric input device, and/or an audio input device. A single component such as a touch screen may function as both an output device of media output component 615 and input device 620.

User computer device 602 may also include a communication interface 625, communicatively coupled to a remote device such as HPCT computer device 510 (shown in FIG. 5). Communication interface 625 may include, for example, a wired or wireless network adapter and/or a wireless data transceiver for use with a mobile telecommunications network.

Stored in memory area 610 are, for example, computer-readable instructions for providing a user interface to user 601 via media output component 615 and, optionally, receiving and processing input from input device 620. A user interface may include, among other possibilities, a web browser and/or a client application. Web browsers enable users, such as user 601, to display and interact with media and other information typically embedded on a web page or a website from HPCT computer device 510. A client application allows user 601 to interact with, for example, HPCT computer device 510. For example, instructions may be stored by a cloud service, and the output of the execution of the instructions sent to the media output component 615.

Processor 605 executes computer-executable instructions for implementing aspects of the disclosure. In some embodiments, the processor 605 is transformed into a special purpose microprocessor by executing computer-executable instructions or by otherwise being programmed.

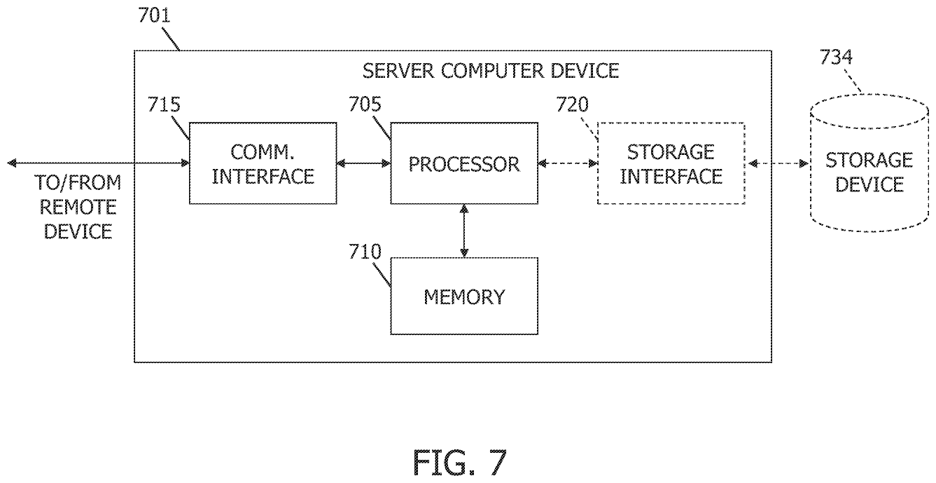

FIG. 7 illustrates an example configuration of the server system shown in FIG. 5, in accordance with one embodiment of the present disclosure. Server computer device 701 may include, but is not limited to, HPCT computer device 510 and database server 515 (both shown in FIG. 5). Server computer device 701 also includes a processor 705 for executing instructions. Instructions may be stored in a memory area 710. Processor 705 may include one or more processing units (e.g., in a multi-core configuration).

Processor 705 is operatively coupled to a communication interface 715 such that server computer device 701 is capable of communicating with a remote device such as another server computer device 701, another HPCT computer device 510, or user computer device 505 (shown in FIG. 5). For example, communication interface 715 may receive requests from user computer devices 505 via the Internet, as illustrated in FIG. 5.

Processor 705 may also be operatively coupled to a storage device 734. Storage device 734 is any computer-operated hardware suitable for storing and/or retrieving data, such as, but not limited to, data associated with database 520 (shown in FIG. 5). In some embodiments, storage device 734 is integrated in server computer device 701. For example, server computer device 701 may include one or more hard disk drives as storage device 734. In other embodiments, storage device 734 is external to server computer device 701 and may be accessed by a plurality of server computer devices 701. For example, storage device 734 may include a storage area network (SAN), a network attached storage (NAS) system, and/or multiple storage units such as hard disks and/or solid state disks in a redundant array of inexpensive disks (RAID) configuration.

In some embodiments, processor 705 is operatively coupled to storage device 734 via a storage interface 720. Storage interface 720 is any component capable of providing processor 705 with access to storage device 734. Storage interface 720 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing processor 705 with access to storage device 734.

Processor 705 executes computer-executable instructions for implementing aspects of the disclosure. In some embodiments, the processor 705 is transformed into a special purpose microprocessor by executing computer-executable instructions or by otherwise being programmed. For example, the processor 705 is programmed with instructions such as illustrated in FIGS. 2-4.

FIG. 8 is an example graph 800 for illustrating the results of analysis performed by the processes 200, 300, and 400 (shown in FIGS. 2-4) using the system 100 (shown in FIG. 1). Graph 800 illustrates the predicted values 802 based on the model. The graph 800 also illustrates the compound threshold 804 generated by the random probability distribution curve component 122 (shown in FIG. 1). The system 100 compares the predicted values 802 to the compound threshold 804 to determine when an alarm should be triggered. In the example embodiment, the system 100 triggers an alarm when the predicted values line 802 exceeds the compound threshold line 804. In some further embodiments, the system 100 triggers the alarm when the predicted values line 802 exceeds the compound threshold line 804 a predetermined number of times within a predetermined period of time. The predetermined number of times and the predetermined period of time may be set by the model based on training or by the user.

At least one of the technical solutions achieved by this system to address technical problems may include: (i) improved analysis of tool functionality; (ii) decreased loss of material due to malfunction or improper tool maintenance; (iii) increased speed in tool analysis; (iv) increased accuracy in tool analysis; (v) reduced unnecessary adjustments to the tool; and (vi) reduced false positives and false negatives; and (vii) reduced overfitting errors.

The implementations described herein relate to systems and methods for enhanced machine learning and, more specifically, to enhance machine learning for anomaly detection using hierarchical prediction and compound thresholds. More specifically, an anomaly detection analysis model is executed by a computing device to (1) determine current conditions of a tool; (2) predict a future state of the tool based on the current conditions and the model; and (3) determine if adjustments need to be made to the tool based on the future state. The systems and methods described herein provide for permitting tool condition feedback in less time, allowing adjustments that can be made to improve maintenance of tools with less lag time for improved quality control and/or product yield. Described herein are computer systems such as the Hierarchical Prediction with Compound Thresholds (HPCT) computer devices and related computer systems. As described herein, all such computer systems include a processor and a memory. However, any processor in a computer device referred to herein may also refer to one or more processors wherein the processor may be in one computing device or a plurality of computing devices acting in parallel. Additionally, any memory in a computer device referred to herein may also refer to one or more memories wherein the memories may be in one computing device or a plurality of computing devices acting in parallel.

Additionally, the computer systems discussed herein may include additional, less, or alternate functionality, including that discussed elsewhere herein. The computer systems discussed herein may include or be implemented via computer-executable instructions stored on non-transitory computer-readable media or medium.

In some embodiments, the design system is configured to implement machine learning, such that the neural network “learns” to analyze, organize, and/or process data without being explicitly programmed. Machine learning may be implemented through machine learning (ML) methods and algorithms. In an embodiment, a machine learning (ML) module is configured to implement ML methods and algorithms. In some embodiments, ML methods and algorithms are applied to data inputs and generate machine learning (ML) outputs. Data inputs may include but are not limited to: analog and digital signals (e.g. sound, light, motion, natural phenomena, etc.) Data inputs may further include: sensor data, image data, video data, and telematics data. ML outputs may include but are not limited to: digital signals (e.g. information data converted from natural phenomena). ML outputs may further include: speech recognition, image or video recognition, medical diagnoses, statistical or financial models, processed signals, signal recognition and identification, autonomous vehicle decision-making models, robotics behavior modeling, signal detection, fraud detection analysis, user input recommendations and personalization, game AI, skill acquisition, targeted marketing, big data visualization, weather forecasting, and/or information extracted about a computer device, a user, a home, a vehicle, or a party of a transaction. In some embodiments, data inputs may include certain ML outputs.

In some embodiments, at least one of a plurality of ML methods and algorithms may be applied, which may include but are not limited to: linear or logistic regression, instance-based algorithms, regularization algorithms, decision trees, Bayesian networks, cluster analysis, association rule learning, artificial neural networks, deep learning, recurrent neural networks, Monte Carlo search trees, generative adversarial networks, dimensionality reduction, and support vector machines. In various embodiments, the implemented ML methods and algorithms are directed toward at least one of a plurality of categorizations of machine learning, such as supervised learning, unsupervised learning, and reinforcement learning.

In one embodiment, ML methods and algorithms are directed toward supervised learning, which involves identifying patterns in existing data to make predictions about subsequently received data. Specifically, ML methods and algorithms directed toward supervised learning are “trained” through training data, which includes example inputs and associated example outputs. Based on the training data, the ML methods and algorithms may generate a predictive function which maps outputs to inputs and utilize the predictive function to generate ML outputs based on data inputs. The example inputs and example outputs of the training data may include any of the data inputs or ML outputs described above. For example, a ML module may receive training data comprising data associated with different signals received and their corresponding classifications, generate a model which maps the signal data to the classification data, and recognize future signals and determine their corresponding categories.

In another embodiment, ML methods and algorithms are directed toward unsupervised learning, which involves finding meaningful relationships in unorganized data. Unlike supervised learning, unsupervised learning does not involve user-initiated training based on example inputs with associated outputs. Rather, in unsupervised learning, unlabeled data, which may be any combination of data inputs and/or ML outputs as described above, is organized according to an algorithm-determined relationship. In an embodiment, a ML module coupled to or in communication with the design system or integrated as a component of the design system receives unlabeled data comprising event data, financial data, social data, geographic data, cultural data, signal data, and political data, and the ML module employs an unsupervised learning method such as “clustering” to identify patterns and organize the unlabeled data into meaningful groups. The newly organized data may be used, for example, to extract further information about the potential classifications.

In yet another embodiment, ML methods and algorithms are directed toward reinforcement learning, which involves optimizing outputs based on feedback from a reward signal. Specifically ML methods and algorithms directed toward reinforcement learning may receive a user-defined reward signal definition, receive a data input, utilize a decision-making model to generate a ML output based on the data input, receive a reward signal based on the reward signal definition and the ML output, and alter the decision-making model so as to receive a stronger reward signal for subsequently generated ML outputs. The reward signal definition may be based on any of the data inputs or ML outputs described above. In an embodiment, a ML module implements reinforcement learning in a user recommendation application. The ML module may utilize a decision-making model to generate a ranked list of options based on user information received from the user and may further receive selection data based on a user selection of one of the ranked options. A reward signal may be generated based on comparing the selection data to the ranking of the selected option. The ML module may update the decision-making model such that subsequently generated rankings more accurately predict optimal constraints.

The computer-implemented methods discussed herein may include additional, less, or alternate actions, including those discussed elsewhere herein. The methods may be implemented via one or more local or remote processors, transceivers, servers, and/or sensors (such as processors, transceivers, servers, and/or sensors mounted on vehicles or mobile devices, or associated with smart infrastructure or remote servers), and/or via computer-executable instructions stored on non-transitory computer-readable media or medium.

As used herein, a processor may include any programmable system including systems using micro-controllers, reduced instruction set circuits (RISC), application-specific integrated circuits (ASICs), logic circuits, and any other circuit or processor capable of executing the functions described herein. The above examples are example only and are thus not intended to limit in any way the definition and/or meaning of the term “processor.”

As used herein, the term “database” may refer to either a body of data, a relational database management system (RDBMS), or to both. As used herein, a database may include any collection of data including hierarchical databases, relational databases, flat file databases, object-relational databases, object oriented databases, and any other structured collection of records or data that is stored in a computer system. The above examples are example only, and thus are not intended to limit in any way the definition and/or meaning of the term database. Examples of RDBMS' include, but are not limited to including, Oracle® Database, MySQL, IBM® DB2, Microsoft® SQL Server, Sybase®, and PostgreSQL. However, any database may be used that enables the systems and methods described herein. (Oracle is a registered trademark of Oracle Corporation, Redwood Shores, Calif.; IBM is a registered trademark of International Business Machines Corporation, Armonk, N.Y.; Microsoft is a registered trademark of Microsoft Corporation, Redmond, Wash.; and Sybase is a registered trademark of Sybase, Dublin, Calif.) p In another embodiment, a computer program is provided, and the program is embodied on a computer-readable medium. In an example embodiment, the system is executed on a single computer system, without requiring a connection to a server computer. In a further example embodiment, the system is being run in a Windows® environment (Windows is a registered trademark of Microsoft Corporation, Redmond, Wash.). In yet another embodiment, the system is run on a mainframe environment and a UNIX® server environment (UNIX is a registered trademark of X/Open Company Limited located in Reading, Berkshire, United Kingdom). In a further embodiment, the system is run on an iOS® environment (iOS is a registered trademark of Cisco Systems, Inc. located in San Jose, Calif.). In yet a further embodiment, the system is run on a Mac OS® environment (Mac OS is a registered trademark of Apple Inc. located in Cupertino, Calif.). In still yet a further embodiment, the system is run on Android® OS (Android is a registered trademark of Google, Inc. of Mountain View, Calif.). In another embodiment, the system is run on Linux® OS (Linux is a registered trademark of Linus Torvalds of Boston, Mass.). The application is flexible and designed to run in various different environments without compromising any major functionality. In some embodiments, the system includes multiple components distributed among a plurality of computing devices. One or more components are in the form of computer-executable instructions embodied in a computer-readable medium. The systems and processes are not limited to the specific embodiments described herein. In addition, components of each system and each process can be practiced independently and separately from other components and processes described herein. Each component and process can also be used in combination with other assembly packages and processes.

As used herein, an element or step recited in the singular and proceeded with the word “a” or “an” should be understood as not excluding plural elements or steps, unless such exclusion is explicitly recited. Furthermore, references to “example embodiment” or “one embodiment” of the present disclosure are not intended to be interpreted as excluding the existence of additional embodiments that also incorporate the recited features.

As used herein, the terms “software” and “firmware” are interchangeable, and include any computer program stored in memory for execution by a processor, including RAM memory, ROM memory, EPROM memory, EEPROM memory, and non-volatile RAM (NVRAM) memory. The above memory types are example only, and are thus not limiting as to the types of memory usable for storage of a computer program.

Furthermore, as used herein, the term “real-time” refers to at least one of the time of occurrence of the associated events, the time of measurement and collection of predetermined data, the time to process the data, and the time of a system response to the events and the environment. In the embodiments described herein, these activities and events occur substantially instantaneously.

The systems and processes are not limited to the specific embodiments described herein. In addition, components of each system and each process can be practiced independent and separate from other components and processes described herein. Each component and process also can be used in combination with other assembly packages and processes.

Additionally, the computer systems discussed herein may include additional, less, or alternate functionality, including that discussed elsewhere herein. The computer systems discussed herein may include or be implemented via computer-executable instructions stored on non-transitory computer-readable media or medium.

A processor or a processing element may be trained using supervised or unsupervised machine learning, and the machine learning program may employ a neural network, which may be a convolutional neural network, a deep learning neural network, a reinforced or reinforcement learning module or program, or a combined learning module or program that learns in two or more fields or areas of interest. Machine learning may involve identifying and recognizing patterns in existing data in order to facilitate making predictions for subsequent data. Models may be created based upon example inputs in order to make valid and reliable predictions for novel inputs.

Additionally or alternatively, the machine learning programs may be trained by inputting sample datasets or certain data into the programs, such as images, object statistics and information, historical estimates, and/or actual repair costs. The machine learning programs may utilize deep learning algorithms that may be primarily focused on pattern recognition, and may be trained after processing multiple examples. The machine learning programs may include Bayesian Program Learning (BPL), voice recognition and synthesis, image or object recognition, optical character recognition, and/or natural language processing—either individually or in combination. The machine learning programs may also include natural language processing, semantic analysis, automatic reasoning, and/or machine learning.

Supervised and unsupervised machine learning techniques may be used. In supervised machine learning, a processing element may be provided with example inputs and their associated outputs, and may seek to discover a general rule that maps inputs to outputs, so that when subsequent novel inputs are provided the processing element may, based upon the discovered rule, accurately predict the correct output. In unsupervised machine learning, the processing element may be required to find its own structure in unlabeled example inputs. In one embodiment, machine learning techniques may be used to extract data about tool wear and usage to predict future states.

Based upon these analyses, the processing element may learn how to identify characteristics and patterns that may then be applied to analyzing image data, model data, and/or other data. For example, the processing element may learn, to identify trends that precede a tool coming out of alignment or having another issue based upon comparisons of pre-tool and post-tool measurements. The processing element may also learn how to identify trends that may not be readily apparent based upon collected scan data, such as trends that precede a tool coming out of alignment.

The methods and system described herein may be implemented using computer programming or engineering techniques including computer software, firmware, hardware, or any combination or subset. As disclosed above, at least one technical problem with prior systems is that there is a need for systems for a cost-effective and reliable manner for analyzing data to predict future tool state and performance. The system and methods described herein address that technical problem. Additionally, at least one of the technical solutions provided by this system to overcome technical problems may include: (i) improved analysis of tool functionality; (ii) decreased loss of material due to malfunction or improper tool maintenance; (iii) increased speed in tool analysis; (iv) increased accuracy in tool analysis; (v) reduced unnecessary adjustments to the tool; and (vi) reduced false positives and false negatives; and (vii) reduced overfitting errors.

The methods and systems described may be implemented using computer programming or engineering techniques including computer software, firmware, hardware, or any combination or subset thereof, wherein the technical effects may be achieved by performing at least one of the following steps: a) receive a plurality of real-time datasets from one or more sensors associated with a tool to be analyzed; b) calibrate the plurality of real-time datasets; c) generate a time slide window for each real-time dataset of the plurality of real-time datasets; d) generate a random probability distribution curve; e) compare the random probability distribution curve to each time slide window to determine if the time slide window includes anomaly data; f) generate prediction results based on the comparison, wherein the prediction results indicate a potential future issue with the tool to be analyzed; g) execute an anomaly prediction model on each real-time dataset of the plurality of real-time datasets to determine if the real-time dataset includes anomaly data; h) compare the determination if the real-time dataset includes anomaly data to the determination if the corresponding time slide window includes anomaly data; i) generate prediction results based on the comparison of the two determinations; j) train the anomaly prediction model using a plurality of training datasets; k) generate the plurality of training datasets by removing datasets with anomalies where the anomaly is not associated with the tool being measured and by removing noisy data; l) extract a plurality of raw datasets; m) classify the plurality of raw datasets as either normal or abnormal; n) for each abnormal dataset, determine if an observed anomaly is associated with a tool being observed and another source; o) if the observe anomaly is associated with another source, remove the corresponding abnormal dataset; p) align the remaining plurality of datasets to match time period; q) clean any noisy datasets; r) generate the plurality of training datasets using the remaining plurality of datasets; s) perform data clustering on the remaining plurality of datasets to determine one or more relationships with the remaining plurality of datasets; t) align the plurality of real-time datasets; u) adjust an amount of time in each of the real-time datasets to be equal to a predetermined amount of time; v) adjust each real-time dataset to include a predetermined amount of time; w) adjust to include a predetermined number of data points from the one or more sensors; x) generate the time slide window by combining each real-time dataset with real-time data for a predetermined period of time prior to the corresponding real-time dataset; and y) raise an alarm when a future issue is detected.

The methods may be implemented via one or more local or remote processors, transceivers, servers, and/or sensors (such as processors, transceivers, servers, and/or sensors mounted on vehicles or mobile devices, or associated with smart infrastructure or remote servers), and/or via computer-executable instructions stored on non-transitory computer-readable media or medium. Additionally, the computer systems discussed herein may include additional, less, or alternate functionality, including that discussed elsewhere herein. The computer systems discussed herein may include or be implemented via computer-executable instructions stored on non-transitory computer-readable media or medium.

As used herein, the term “non-transitory computer-readable media” is intended to be representative of any tangible computer-based device implemented in any method or technology for short-term and long-term storage of information, such as, computer-readable instructions, data structures, program modules and sub-modules, or other data in any device. Therefore, the methods described herein may be encoded as executable instructions embodied in a tangible, non-transitory, computer readable medium, including, without limitation, a storage device and/or a memory device. Such instructions, when executed by a processor, cause the processor to perform at least a portion of the methods described herein. Moreover, as used herein, the term “non-transitory computer-readable media” includes all tangible, computer-readable media, including, without limitation, non-transitory computer storage devices, including, without limitation, volatile and nonvolatile media, and removable and non-removable media such as a firmware, physical and virtual storage, CD-ROMs, DVDs, and any other digital source such as a network or the Internet, as well as yet to be developed digital means, with the sole exception being a transitory, propagating signal.

This written description uses examples to disclose various implementations, including the best mode, and also to enable any person skilled in the art to practice the various implementations, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

When introducing elements of the present disclosure or the embodiment(s) thereof, the articles “a”, “an”, “the” and “said” are intended to mean that there are one or more of the elements. The terms “comprising,” “including,” “containing” and “having” are intended to be inclusive and mean that there may be additional elements other than the listed elements. The use of terms indicating a particular orientation (e.g., “top”, “bottom”, “side”, etc.) is for convenience of description and does not require any particular orientation of the item described.

As various changes could be made in the above constructions and methods without departing from the scope of the disclosure, it is intended that all matter contained in the above description and shown in the accompanying drawing(s) shall be interpreted as illustrative and not in a limiting sense.

What is claimed is:

1. A computer device comprising at least one processor in communication with at least one memory device, wherein the at least one processor is programmed to:
receive a plurality of real-time datasets from one or more sensors associated with a tool to be analyzed;
calibrate the plurality of real-time datasets;
generate a time slide window for each real-time dataset of the plurality of real-time datasets;
generate a random probability distribution curve;
compare the random probability distribution curve to each time slide window to determine if the time slide window includes anomaly data; and
generate prediction results based on the comparison.

2. The computer device in accordance with claim 1, wherein the at least one processor is further programmed to execute an anomaly prediction model on each real-time dataset of the plurality of real-time datasets to determine if the real-time dataset includes anomaly data.

3. The computer device in accordance with claim 2, wherein the at least one processor is further programmed to compare the determination if the real-time dataset includes anomaly data to the determination if the corresponding time slide window includes anomaly data.

4. The computer device in accordance with claim 3, wherein the at least one processor is further programmed to generate prediction results based on the comparison of the two determinations.

5. The computer device in accordance with claim 2, wherein the at least one processor is further programmed to train the anomaly prediction model using a plurality of training datasets.

6. The computer device in accordance with claim 5, wherein the at least one processor is further programmed to generate the plurality of training datasets by removing datasets with anomalies where the anomaly is not associated with the tool being measured and by removing noisy data.

7. The computer device in accordance with claim 6, wherein the at least one processor is further programmed to:
extract a plurality of raw datasets;
classify the plurality of raw datasets as either normal or abnormal;
for each abnormal dataset, determine if an observed anomaly is associated with a tool being observed and another source;
if the observe anomaly is associated with another source, remove the corresponding abnormal dataset;
align the remaining plurality of datasets to match time period;
clean any noisy datasets; and
generate the plurality of training datasets using the remaining plurality of datasets.

8. The computer device in accordance with claim 7, wherein the at least one processor is further programmed to perform data clustering on the remaining plurality of datasets to determine one or more relationships with the remaining plurality of datasets.

9. The computer device in accordance with claim 1, wherein the at least one processor is further programmed to:
align the plurality of real-time datasets; and
adjust an amount of time in each of the real-time datasets to be equal to a predetermined amount of time.

10. The computer device in accordance with claim 9, wherein the at least one processor is further programmed to adjust each real-time dataset to include a predetermined amount of time.

11. The computer device in accordance with claim 9, wherein the at least one processor is further programmed to adjust to include a predetermined number of data points from the one or more sensors.

12. The computer device in accordance with claim 1, wherein the at least one processor is further programmed to generate the time slide window by combining each real-time dataset with real-time data for a predetermined period of time prior to the corresponding real-time dataset.

13. The computer device in accordance with claim 1, wherein the prediction results indicate a potential future issue with the tool to be analyzed.

14. The computer device in accordance with claim 1, wherein the at least one processor is further programmed to raise an alarm when a future issue is detected.

15. A method for analyzing a tool, the method implemented on a computer device comprising at least one processor in communication with at least one memory device, wherein the method comprises:
receiving a plurality of real-time datasets from one or more sensors associated with a tool to be analyzed;
calibrating the plurality of real-time datasets;
generating a time slide window for each real-time dataset of the plurality of real-time datasets;
generating a random probability distribution curve;
comparing the random probability distribution curve to each time slide window to determine if the time slide window includes anomaly data; and
generating prediction results based on the comparison.

16. The method of claim 15 further comprising executing an anomaly prediction model on each real-time dataset of the plurality of real-time datasets to determine if the real-time dataset includes anomaly data.

17. The method of claim 16 further comprising:
comparing the determination if the real-time dataset includes anomaly data to the determination if the corresponding time slide window includes anomaly data; and
generating prediction results based on the comparison of the two determinations.

18. The method of claim 16 further comprising:
training the anomaly prediction model using a plurality of training datasets, wherein the plurality of training datasets are generated by:
extracting a plurality of raw datasets;
classifying the plurality of raw datasets as either normal or abnormal;
for each abnormal dataset, determining if an observed anomaly is associated with a tool being observed and another source;
if the observe anomaly is associated with another source, removing the corresponding abnormal dataset;
aligning the remaining plurality of datasets to match time period;
cleaning any noisy datasets; and
generating the plurality of training datasets using the remaining plurality of datasets.

19. The method of claim 15 further comprising:
aligning the plurality of real-time datasets; and
adjusting an amount of time in each of the real-time datasets to be equal to a predetermined amount of time by adjusting each real-time dataset to include at least one of a predetermined amount of time and a predetermined number of data points from the one or more sensors.

20. The method claim 15 further comprising generating the time slide window by combining each real-time dataset with real-time data for a predetermined period of time prior to the corresponding real-time dataset.
